(19) United States
(12) Patent Application Publication
(10) Pub. No.: US 2025/0217859 A1
(43) Pub. Date: Jul. 3, 2025

(54) Method and System for an Online Beverage Builder

(71) Applicants: Stephen Warth, Corona, CA (US); Alisha Warth, Corona, CA (US)

(72) Inventors: Stephen Warth, Corona, CA (US); Alisha Warth, Corona, CA (US)

(21) Appl. No.: 18/397,869

(22) Filed: Dec. 27, 2023

(51) Int. Cl. G06Q 30/0601; A23L 2/56; A23L 2/58; A23L 2/60; B67C 3/00; B67C 7/00; G06Q 50/04

(52) U.S. Cl. CPC G06Q 30/0621; G06Q 30/0641; G06Q 50/04

(57) ABSTRACT

The present invention generally concerns a method and system that remotely streamlines the manufacturing of commercial beverages. More specially, a client uses an internet-ready computer to access a manufacturer's server to create a shelf stable beverage formulation. A website presents the client with a selection of dynamic beverage attributes that initiate the design, manufacture, and delivery of at least one type of made-to-order beverage, being a blend of a beverage base with multiple ingredients that are poured, packaged, and sealed into a custom bottle or can. A client may upload custom artwork and/or other written information for package labeling. All client selections are submitted within the remote system. One can view live second by second pricing based on client selections. The present invention triggers real-world manufacturing of commercial ready to drink beverages with custom labeling and artwork. Final formulations are optionally delivered to the client for consumption or resale.

### RELATED APPLICATIONS

This non-provisional patent application does not claim priority to any other patent application.

### FIELD OF THE INVENTION

The present invention generally concerns a method and system that remotely streamlines the manufacturing of commercial beverages. More specially, a client uses an internet-ready computer to access a manufacturer's server to create a shelf stable beverage formulation. A website presents the client with a selection of dynamic beverage attributes that initiate the design, manufacture, and delivery of at least one type of made-to-order beverage, being a blend of a beverage base with multiple ingredients that are poured, packaged, and sealed into a custom bottle or can. A client may upload custom artwork and/or other written information for package labeling. All client selections are submitted within the remote system. One can view live second by second pricing based on client selections. The present invention triggers real-world manufacturing of commercial ready to drink beverages with custom labeling and artwork. Final formulations are optionally delivered to the client for consumption or resale.

### BACKGROUND OF THE INVENTION

People love soft drinks like Coca-Cola®, Pepsi®, and Dr. Pepper®. Soft drinks are not just fizzy sodas. They can be fruit beverages, bottled water and coffees, functional beverages like energy drinks, sports drinks like Gatorade®, and many more. Consumers rarely consider the effort it takes to place a beverage on store shelves and into their hands. For a novice wanting to enter the industry, creating a commercial beverage takes a lot of know-how. The cost of entry into beverage manufacturing is steep. The costs of raw materials, manufacturing, and marketing are all heavy tolls, and at least two systems (concentrate manufacturing and soft drink manufacturing) must coordinate their efforts and products to formulate a shelf stable beverage.

The life of a soft drink can have three parents: a beverage base manufacturer, a bottling company, and possibly a distributor placing the ready to drink beverage on store shelves. Beverage base manufacturers create flavored syrups, concentrates, and powders for soft drink manufacturers to then blend with water and other ingredients to package and sell as the recognizable drinks that people consume. Typically, beverage base manufacturers contract with bottlers that then manipulate various bases to make, package, and distribute the soft drink.

Beverage manufacturing falls within the art of food science and FDA regulations. An example being 21 CFR § 165, which regulates commercial beverage manufacturers when selling their products in the United States. FDA guidelines give oversight to the careful balance of processing aids, acidulants, sweeteners, flavors, and nutritional ingredients blended in commercial beverage formulations. Because of this, the time frame for creating a stable recipe with a desired taste, color, and purpose can take anywhere from nine months or up to one year or longer from conception to final product.

A novice wanting to make and sell their own commercial beverage must appreciate the importance of each step within a beverage production line and its various controls. From the time it takes to formulate a chemically stable and refreshing beverage, to understanding how the machines are used in mass production, making a commercial beverage includes a lot of moving parts. However, a few global steps are common, including but not limited to: water purification, filtration, and de-chlorination, formulation of ingredients and the blending thereof, optional carbonation processes, and, then, packaging and labeling.

Water purification includes multiple filtration and cleaning steps to be free of dirt or other microorganisms, which are found in most city water supplies and other potable water sources. Water used in the beverage industry undergoes a clarification process that includes machines that coagulate the water to remove particles, the filtering of the water through sand or gravel, water chlorination and subsequent de-chlorination with carbon filters, reverse osmosis, and, possibly, ultra-violet treatment.

Water is then used as a carrier for mixed ingredients to create a beverage base being a blend of water, syrups, flavoring components, sweeteners, coloring additives, and nutritional fortification additives. The final mixture is a recipe for the specific type of beverage one wants. The ingredients truly define the type of beverage that's created, and the amount of ingredients used in the final formulation can also depend on the size of the container, the container's material, the additional additives, and whether the drink will be carbonated or non-carbonated.

A production line for ready-made beverages can easily have up to fourteen machines that can include without limitation: a machine for the preparation of sugars and syrups, a sugar press machine, a flavor blending tank, a homogenization machine, a tank for holding the final formulation, a carbonation machine, as carbonated beverages need CO₂ injected into the cold liquid under precise temperature and pressure settings, and five to six other machines specifically for the containing, packaging, and labeling of the bottle or can that will eventually hold the beverage.

Beverage packaging, either as a bottle or a can, presents its own issues. An aluminum can's inner surfaces must be passivated with a tin-coated aluminum alloy or low-carbon steel and be a BPA free or BPA-NI (BPA Non-Intent) coating to prevent corrosion. The can holding the beverage is then sealed immediately with pressure caps made of aluminum or a similar metal and are then refrigerated in a cold room before being labeled to avoid condensation. The body of the bottle or can holding the beverage is then labeled per FDA guidelines giving the additives and contact substances, nutritional information, the name and address of the manufacturer, the net quantity of the beverage, a listing of the chemical preservatives and their functions, a listing of the use of certain amino acids or benzene or benzene-based salts, and the like.

The present invention includes a website that gives a client needing a custom commercial beverage the power to streamline the design, manufacturing, packaging, and shipping of the same. The present invention combines the systems of beverage base and soft drink manufacturing to allow a client to create a commercial beverage without any prior industry knowledge or authorities. Client selections of dynamic beverage attributes inform a manufacturer on beverage type, the beverage base to be used, what customizable attributes to include, bottle and/or can sizes, and details for custom packaging and shipping for eventual consumption or resale.

U.S. Pat. App. No. 2023/0029220 as filed by Hall, Douglas B., et al. (the '220 application) discloses a method and machine to create a personalized recipe for a distilled spirit. The method includes two options for a user to create a whiskey blend for an individualized liquor recipe that is sent to a machine for blending and dispensing. The first option presents the user with an array of liquors or wines to sample. The user then makes notes as to the flavor characteristics and blend of the drink. The user mixes selected samples into a separate container. The amount of each liquor used during the mixing phase is recorded to create a final recipe based on the user's pallet. The recipe, as written by the user, is then typed into a computer that is network ready and connected to a database that stores and compares the user's recipe to alternative drink recipes of experts to give an alternative drink mixture. The final recipe is sent to a blending machine having an interface, where a graphic that is associated with each beverage blend is presented at the machine to reproduce. The user sends the recipe to the machine via the internet. The blending machine is connected to multiple containers having each of the recipe's ingredients. The final beverage can then be dispensed in a bottle having a prepared label. The volume of the final bottled whiskey is dependent upon the user's volumetric selection when creating the initial blended whiskey. The second option includes the user being asked a series of questions in a decision tree to make a blended whiskey. The decision tree is used in lieu of the user actually sampling an array of whiskeys. These questions can be related to statements, images, existing whiskey brands, sounds, and aromas. In any event, the user's recipe is a volume dependent blend of ready-made alcohols, where the final recipe is compared to expert recipes and fed into a blending machine for blending and bottling.

U.S. Pat. No. 10,043,226 to Craparo, John S., et al. (the '226 patent) discloses an apparatus and method for making a drink via a networked machine. The system is a kiosk for making brewed beverages based on user selections of recipes, where the system has three core elements: the kiosk, an electronic control unit, and a central host. The kiosk is a fully automated machine that exchanges information with a central host via selections made at a user interface to select from various drink recipes, which can be shared from one user to another to review, modify, or order such drinks. The central host sends commands to the electronic control unit via a GUI interface at the kiosk to carry out the creation and dispensing of different drinks. The electronic control unit is the heart of the machine. It controls the production and dispensing of the beverage through a series of valves, heaters, pumps, water tanks, coffee bean holders and grinders, servo motors, cup handlers, liquid and dispensers, and the like. If the electronic unit is the heart of the machine, then the central host is the brain. The central host is a database that is configured to perform many functions including the taking of user orders via a graphical user interface at the kiosk, storage and managing of customer information, storing beverage recipes, storing beverage production queues, and the managing of other remotely connected kiosks. The '226 patent details a highly complicated machine for creating and dispensing brewed drinks via user selection at a walkup kiosk that allows the user to share their recipe with others.

U.S. Pat. App. No. 2012/0285986 as filed by Irvin, Jason B. (the '986 patent application) discloses a system and method for creating beverages. The system is a networked kiosk that allows a user to create a customizable drink by selecting from a variety of pre-programmed drink options including drink bases, ingredients, add-ins, herbal supplements, vitamins, and the like. The ingredients may include nutritional supplements, liquid peanut butter, powdered fruit juice, powdered yogurt, water, purees, flavor syrups, and milk. Each ingredient is housed in one of sixteen hoppers affixed to a rotating carousel. Each hopper rotates to a position just above a cup and the ingredient is dispensed therein. Based on the kiosk's location, each hopper contains specific ingredients for drinks that are location specific, e.g. ingredients for an energy drink being made at a kiosk located at a gym or ingredients for sweet tea being made by a kiosk located at a bar-b-que restaurant. Drinks are mixed and blended inside and dispensed from the kiosk. As with other drink machines like this, there are network options giving the user flexibility in how and when the drink is ordered and created.

U.S. Pat. No. 10,262,281 to Vitek, James, G., et al. concerns a method and system for tracking pizza delivery orders via a decentralized ordering system. This method is a version of the Domino's Pizza® tracker available on their website. The patent uses computers, servers, and internet connections for a user to place and track their pizza order being fulfilled at a decentralized location. The patent allows Domino's Pizza® franchises to use a centralized order status system and a master system within the restaurant network to transfer order status information to the central system accessible by the customer. There is a single number identifier that connects a customer to a specific order being tracked. The system has the ability to notify the customer if the order status has changed over the internet via email or other means. Notification messages might include: “pizza being made,” “pizza in the oven,” “pizza being packaged for delivery,” and “pizza on delivery vehicle.” Because the system communicates via computers, servers, and the world wide web, the invention uses protocols and markup languages including: HTTP, XML, URLs for navigation, web browsers, and the like.

For these reasons, there is a need for an invention that remotely streamlines the design, manufacture, packaging, and shipping of custom commercial beverages for consumption or resale as created and ordered by a client. The present invention allows a client to alter proprietary concentrates via the dynamic selection of Core and Customizable Beverage Attributes, whereby order payment triggers manufacturing and shipping of the same by a beverage manufacturer.

### SUMMARY OF THE INVENTION

An object of the present invention is a method to remotely streamline a beverage manufacturing process by: a beverage manufacturer providing a website over a network for a client to select two Core Beverage Attributes and to select a series of Customizable Beverage Attributes to create a custom beverage formulation. The client using the website to submit payment to the manufacturer for the custom beverage formulation thereby initiating the manufacture, packaging, and shipping of a custom beverage to the client.

It is an object of the present invention wherein the client uses the website to upload custom artwork and text information for the beverage manufacturer to extract and use to label packaging for a beverage container.

It is an object of the present invention wherein the two Core Beverage Attributes include a Beverage Type and a Beverage Base.

It is an object of the present invention wherein the series of Customizable Beverage Attributes include: a bottle type, a bottle size, a can size, a choice of bottle cap color, a choice of can lid type and color, a primary flavor, a secondary flavor, a selection of nutrients, a selection of sweeteners, a selection of optional color additives, and any combinations thereof.

It is an object of the present invention wherein the bottle type includes amped, optic, or a sport type bottle.

It is an object of the present invention wherein the bottle size includes 8 oz to 16 oz bottles.

It is an object of the present invention wherein the can size includes 7.5 oz to 12 oz cans.

It is an object of the present invention wherein the primary and secondary flavors include: apple, apricot, black cherry, blackberry, blueberry, coconut, cola, cotton candy, cranberry, cucumber, dragon fruit, fruit punch, ginger, grape, grapefruit, guava, hibiscus, kiwi, lavender, lemon, lime, mango, mint, mixed berry, nectarine, orange, papaya, passion fruit, peach, pineapple, prickly pear, raspberry, strawberry, vanilla, watermelon, yuzu, and any combinations thereof.

It is an object of the present invention wherein the selection of sweeteners include: cane sugar, Splenda, stevia leaf blend, and any combinations thereof.

It is an object of the present invention wherein the selection of nutrients include: caffeine, vitamin B complex, Vitamin C, L-Theanine, ginseng, and any combinations thereof.

It is an object of the present invention wherein optional additives for coloring include: natural fruit coloring, vegetable extract coloring, synthetic coloring, and any combinations thereof.

It is an object of the present invention wherein the uploaded custom artwork is either in a GIF, a JPEG, a PNG, a TIFF, a BMP, a SVG, an EPS, an AI, or a PDF format.

It is an object of the present invention wherein the manufacturer sends the client a dieline template to create their own custom artwork for packaging and labeling.

It is an object of the present invention wherein the beverage manufacturer can initiate the creation of client's custom beverage by extracting a client formulation from a server to initiate manufacturing of the beverage via a production line capable of weighing client ingredients, water purification and production, mixing and blending of a beverage base with client's ingredients, beverage filing, and beverage labeling.

Another object of the present invention is a method to remotely streamline a beverage manufacturing process by a beverage manufacturer providing a website over a network, a client using the website to select a Core Beverage Attribute to create a custom beverage, the client further using the website to select from a series of Customizable Beverage Attributes including a water type, a can size, and a can lid type to create a custom beverage formulation, and the client using the website to submit payment to the beverage manufacturer for the custom beverage thereby initiating the manufacture, packaging, and shipping of a custom beverage to the client.

It is an object of the present invention wherein the water type is either a purified still water, or a purified sparkling water.

It is an object of the present invention for the can size is from 7.5 oz to 16 oz and the can lid type is standard silver for still or sparkling water beverages.

It is an object of the present invention for the client to use the website to upload custom artwork and text information for the beverage manufacturer to extract and use to label packaging for a beverage container for canned water.

It is an object of the present invention wherein a system remotely streamlines the beverage manufacturing process with a client computer networked to a beverage manufacturer's computing server having at least one relational database with a website having a series of selectable Core Beverage Attributes, selectable Customizable Beverage Attributes, and a payment gateway. The beverage manufacturer's computing server has a storage memory capable of retaining the client selections of Core Beverage Attributes and Customizable Beverage Attributes. The system includes also includes a beverage manufacturer having a second computer capable of communicating with the computing server to extract all of client's Core Beverage Attributes and Customizable Beverage Attributes after client computer has rendered payment via the payment gateway, and the beverage manufacturers' second computer being capable of transferring the extracted Core Beverage Attributes and Core Beverage Attributes to a beverage manufacturers' beverage production facility having at least a laboratory gram resolution scale, a water filtration system having at least reverse osmosis membrane filter, a coconut shell carbon sediment filter, or an ultraviolet spectrum disinfectant for further sterilization, a 5 gallon to 500 gallon NFS open top mixing vessel, an isobaric and atmospheric beverage filling line with an automated or manual empty container infeed, an automatic liquid filling and metering stage, an automatic sealer for the beverage container, a machine for the rinsing and cleaning of the beverage container's exterior, and an automatic roll fed pressure sensitive label applicator and a video inkjet spray date coder; and wherein the beverage manufacturers' second computer is networked with a different remote computer or server operated by a shipping or delivery service.

### BRIEF DESCRIPTION OF DRAWINGS

FIG. 1 depicts a flow diagram for the method of the present invention that streamlines the beverage manufacturing process for novice clients. The invention triggers real world manufacturing and shipping of commercial ready to drink beverages with custom labeling and artwork via client selection and submission of Core and Customizable Beverage Attributes, the uploading of custom images, and payment of the order to a beverage manufacturer. The present invention uses the internet, computers, databases, and a cascading flow of web resources to aid a client in creating a custom beverage for consumption or resale.

FIG. 2 depicts an exemplary landing page for a beverage building website, where the header button marked Beverage Builder initiates the method of the present invention and navigates a client to the next sequence to select Core Beverage Attributes.

FIG. 3 depicts the option flow of choices for a client to select a Core Beverage Attribute being Beverage Type.

FIG. 4 depicts the option flow of choices for a client to select a Core Beverage Attribute being Beverage Base.

FIG. 5 depicts client selections for Customizable Beverage Attributes. After selecting both Beverage Type and Beverage Base, a client is presented with a webpage having a series of nested dropdowns for several categories to further refine the Beverage Base formulation to then submit to a beverage manufacturer. The webpage is depicted within a flow diagram at the manufacturer's server and database. FIG. 5 has menu items to create instructions for bottled drinks. All webpages from beginning to end are taken together to show the system as a dynamic beverage builder, being a general flow of cascading selectable menu items to make a formulation for a custom beverage.

FIG. 6 depicts client selections for Customizable Beverage Attributes. After selecting both Beverage Type and Beverage Base, a client is presented with a webpage having a series of nested dropdowns for several categories to further refine the Beverage Base formulation to then submit to a beverage manufacturer. The webpage is depicted within a flow diagram at the manufacturer's server and database. FIG. 6 has menu items to create instructions for canned drinks. All webpages from beginning to end are taken together to show the system as a dynamic beverage builder, being a general flow of cascading selectable menu items to make a formulation for a custom beverage.

FIG. 7 depicts a table holding menu items within collapsable lists presented to the client as selectable Customizable Beverage Attributes. The table may be held within the manufacturer's database, where each column represents a collapsible list, and each corresponding row represents an item that can be retrieved therefrom. This table is for bottled beverages.

FIG. 8 depicts a table holding menu items within collapsable lists presented to the client as selectable Customizable Beverage Attributes. The table may be held within the manufacturer's database, where each column represents a collapsible list, and each corresponding row represents an item that can be retrieved therefrom. This table is for canned beverages.

FIG. 9 depicts an exemplary shopping cart webpage. The header buttons are the same as for the landing page of FIG. 2. Here, the client is presented with a summary of their selected Core and Customizable Beverage Attributes, pricing, and the option of entering custom text to include on the label of their bottle or can.

FIG. 10 depicts a manufacturing process for the present invention that may include without limitation: the weighing of ingredients, water purification and production, the mixing of ingredients, beverage filling, beverage labeling, and other miscellaneous steps.

FIG. 11 depicts a schematic for the option flow of choices for a client to design a beverage formulation for a canned purified water beverage. The canned water can either be still or carbonated. The client is presented with several Customizable Beverage Attributes to choose from being: a water type, a can size, and a can lid to create a custom beverage.

### DETAILED DESCRIPTION OF THE INVENTION

The following words will describe a web-based platform that gives a client the power to initiate the design, manufacture, packaging, and delivery of a shelf stable beverage for consumption or resale. However, these words are not a limitation on the scope of the present invention but are written to detail certain embodiments thereof. Due to the detailed description, modifications will become apparent to those skilled in the art.

### Definitions

The following non-limiting terms help detail the invention.

The term “beverage” generally refers to a liquid or drink that can be consumed. A beverage can be: a soda, purified carbonated water, purified still water, fruit juices, flavored seltzer water, flavor enhanced water, carbonated or non-carbonated sports drinks, energy drinks, cocktail mixers, energy shots, carbonated or non-carbonated lemonade, pulp and pulp free citrus and non-citrus juices, milk, soy milk, vegetable juices, tea, coffee, alcoholic drinks, vitamin enhanced water, flavored water, flavored punches, and the like. A beverage can be a mixture of a beverage base and at least one other liquid having multiple additives, carbonated or non-carbonated, wherein such a mixture can create some of the above examples.

The term “self-stable beverage” generally refers to a commercially packaged beverage having a highly stable beverage formulation with an increased shelf life as a result of a manufacturing process that considers the removal of oxygen from the system, the reduction of ambient light that impacts the beverage container, and other like considerations.

The terms “Core Beverage Attribute(s)” or “Core Attribute” generally refer to the options of Beverage Type and Beverage Base, which are chosen by the client before being presented with menus for selecting Customizable Beverage Attributes. Having the client initially select from these Core Attributes mimic industry practices of how ready to drink beverages are initially understood, formulated, and blended to a final product per the combined efforts of beverage concentrate manufacturers and contracted soft drink makers.

The terms “Beverage Base,” “selectable beverage bases,” “bases,” or “concentrate” generally refer to a mixture of components that constitutes the foundation for a beverage recipe. The Beverage Base of the present invention is a proprietary formulation that gives a drink its defining taste and personality and is one of two Core Beverage Attributes. For example, there's a beverage base recipe that makes a bottled coffee taste like a vanilla latte, and there's a beverage base that makes a fruit punch taste like certain fruits. The Beverage Base serves as a flavored foundation for the personality of a drink, and they take a very long time to perfect for manufacturing. A Beverage Base may include without limitation: flavor concentrates, flavor syrups, or flavor sweeteners. Any one of these may be further blended with natural or artificial flavors, flavor additives, natural or artificial colors, nutritive or non-nutritive supplements, natural or artificial sweeteners, and tartness controlling additives. Non-limiting examples of additives may include, without limitation, citric acid, potassium citrate, and functional additives such as vitamins, minerals, herbal extracts, nutraceuticals, or medicaments.

The term “Beverage Type” generally refers to a key identifier that soft drink manufacturers use to sell beverage products that is in keeping with people's superficial expectations of commercial beverages, such as still (non-carbonated), sparkling (carbonated), alcoholic, cocktails mixers & shots, or purified water. These options are presented within the present invention as buttons for the client to navigate through the method.

The terms “primary flavor” and “secondary flavor” generally refer to natural flavoring oils, flavor extracts, or artificial flavors used by a beverage manufacturer to enhance the taste of their beverage formulations. Natural flavoring oils and extracts may include without limitation: citrus oils or extracts, other fruit oils or extracts, vanilla extract, vanilla flavoring, oils or extracts from herbs and spices, cola nut oil or extract, or root extracts. Extracts use approximately 35% alcohol solution to suspend the flavor ingredients. It is common for flavoring oils to be extracted from the ingredient, i.e. lemon peels being boiled in an oil and then cooled. However, oils and extracts bought commercially from your local store or from various online merchants have a range of other ingredients, such as isolates, absolutes, essences, oleoresins, and other compounds, and they are made to be water and oil soluble to easily add them to water or alcohol-based beverage formulations. Such sellers of flavoring oils and extracts are LorAnn Oils, Nomeca Food Flavoring Oil, Dolce Foglia, and McCormick®.

The terms “client” or “user” generally refer to any individual person, reseller, organization, entrepreneur, and/or business needing a number of custom-made beverages that use the present invention to connect to the manufacturer's website to initiate the design, manufacture, and delivery of said beverages to their desired location.

The term “manufacturer,” or “beverage manufacturer” generally refers to a person, organization, or business that grants a client permission to use the present invention via computers and the internet. The manufacturer has access to the core machines, beverage bases, additives, and dynamic beverage attributes needed to create the client's final beverage recipe as reflected in client's selection of the same. The manufacturer can fulfill the client's order manually, virtually via an internet-controlled beverage production line, or through more traditional automated beverage production lines known within the art. The client's selection of dynamic beverage attributes and payment submission within the present invention instructs the manufacturer when to initiate the design, manufacture, and delivery of such order to a client's desired location.

The term “beverage builder,” generally refers to another name for the overall process of the present invention that allows the client to initiate the design, manufacture, and delivery of a shelf stable beverage for consumption or resale via a manufacturer's web site through the selection of dynamic beverage attributes, the submission of the beverage order, and the rendering of payment to the manufacture for manufacturing and delivery of the custom beverage.

The terms “dynamic beverage attributes,” “selectable attributes,” “attributes,” or “selectable beverage attributes” generally refer to a series of beverage options having selectable menu items presented over a series of web pages that allow the client to create a beverage recipe. Once the order is submitted and paid for by the client, said payment and the beverage recipe initiates the beverage manufacturing process. Dynamic beverage attributes include a range of selectable options from both Core and Customizable Beverage Attributes from which the client must choose.

The terms “Customized Beverage Attribute(s),” or “Customizable Beverage Attribute(s)” generally refer to a menu of selectable beverage particulars including, but not limited to: primary and secondary flavor options, nutrients, packaging and labeling options, color additives, sweeteners, and the like. Selecting between differing Customizable Beverage Attributes allows the client to further define the final flavor profile of the beverage beyond the beverage base formulation, including how the beverage will be packaged.

The term “digital image” generally refers to a numeric representation (normally binary) of a two-dimensional image, a photo. Depending on whether or not the image resolution is fixed, it may be of vector or raster type. The term may also refer to images that have been compressed. Web browsers can display and facilitate the uploading of standard internet image formats to the manufacturer's server including raw image file types, GIF, JPEG, PNG, TIFF, BMP, SVG, EPS, AI, and PDF formats.

The terms “dieline” or “dieline template” generally refer to a 2D representation of a potentially 3D object used for printing and packaging. It is often used as a guide to show a manufacturer where an artistic object will be printed on a product. A dieline template is a diagram showing all the folds and cut lines of a package in a flattened form.

The term “computer” generally refers to an electronic device or machine whose function is to process, store, and retrieve data based on instructions provided by a software or hardware program. One can access the internet with most modern computers. They are naturally made to perform the method of the present invention by providing the client's computer with a network point to the manufacturer's server, database, and website. A computer typically has a processing unit and one or more memory or other storage devices that can communicate with each other via a bus. The processing unit is made to execute instructions and can display and control aspects of software, firmware, programs, algorithms, scripts, and the like to aid the method of the present invention. Processing units that carry out computer functions are typically designated central processing units (CPUs) or general-purpose graphics processing units (GPGPUs). CPU or GPGPU can optionally contain a cache memory unit for temporary local storage of instructions, data, or computer addresses. The computer may include one or more memory storage devices suitable to store the variety of information just listed. The types of computing machines that can facilitate the present invention may include without limitation: desktop computers, laptop or notebook computers, personal digital assistants, a mainframe, a supercomputer, or a web or computer server. Other computers may include handheld (mobile) computer devices, such as internet capable tablets smartphones/cellphones, a minicomputer, smartwatches, tablets, or personal workstations. The computer should have a basic operating system such as MS Windows, Linux, any of the Mac OSs, Android, and the like. A desktop computer might have additional processors and data storage systems to receive a number of inputs and outputs for communicating information externally, including but not limited to: a keyboard, a mouse, a trackball, a joystick, a touchpad, and/or a microphone, a video camera, a CRT monitor, USB, Thunder Bolt, a printer, audio speakers, and/or an LCD display panel. The additional data storage systems may include machine readable media being: a magnetic storage media, CD-ROM, magnetic optical storage medium, read only memory (ROM), random access memory (RAM), static RAM (SRAM), dynamic RAM (DRAM), phase-change random access memory (PRAM), ferroelectric random-access memory (FRAM), erasable programmable memory (EPROM), USB flash memory, and the like.

The terms “web browser” or “browser” generally refer to a software application that allows a user to access and retrieve content from the internet via hypertext links/uniformed resource locators (URLs). Non-limiting examples of popular web browsers are: Microsoft Edge, Firefox, Google Chrome, Opera, Safari, UR Browser, Tor Browser, or others. Typical web browsers are capable of rendering the coding results of programming languages and software protocols to allow a user to enjoy and manipulate websites hosted by remote servers, where such languages and protocol may include without limitation: Application Programming Interfaces (APIs), Ruby, Liquid, Groovy, HTML, XHMTL, HTML5, DOM, CSS, Java, C++, Pascal, Python, Smalltalk, JavaScript, XML, ColdFusion®, XML/HTTP requests, HTTP/HTTPS/PHP scripts, COBOL, Objective C, Tcl, WebDNA, Active Server Pages (ASP), Perl or the like. One non-limiting embodiment of the present invention includes using a combination of Ruby, Liquid, HTML5, HTML, XML, Delphi, Java, Python, Pascal, CSS, or C++/XHTML as client/developer side scripting languages within a Shopify® platform.

The terms “module” or “modules” generally refer to a part of a computer program that performs a distinct function via a sub-routine, a procedure, a definitional statement, a file, a written section of code, a programming object, a programming structure, and/or a macro. Each module may be separately compiled and linked into a single executable program or can be arbitrarily redistributed to other modules, combined together in a single module, or made available in, for example, a shareable dynamic link library. Non-limiting examples being modules capable of taking requests or giving commands as PHP/JavaScript commands for uploading digital images with a mobile device or home computer to a server over a network, where, for example, a client's computer may use software modules that can convert various protocols used by the present invention into PHP/JavaScript or HTTP/HTTPS/PHP scripts, DOM, CSS, XML, XHTML/HTTP requests, SQL request or commands, or any of the languages listed in the web browser definition.

The terms “internet,” “network,” “web,” or “World Wide Web” generally refer to a collection of computers connected by networked interfaces implementing standard communication technologies and protocols, which may use technologies such as, for example, Ethernet, IEEE 802.11, integrated services digital network (ISDN), digital subscriber line (DSL), and asynchronous transfer mode (ATM), as well as other known communications technologies. The computers can be connected via internet networks such as: personal Area Networks (PANs), Intranet connections, Local Area Networks (LAN), Wide Area Networks (WAN), broadband wireless access (BWA), Wireless Wide Area Networks (WWAN), or wireless local area networks (WLANs). The internet uses common protocols that allow the location and exchange of information between connected computers. These common protocols may include without limitation: multi-protocol label switching (MPLS), the transmission control protocol/Internet protocol (TCP/IP), the User Datagram Protocol (UDP), the hypertext transport protocol (HTTP), the simple mail transfer protocol (SMTP), simple object access protocol (SOAP), and the file transfer protocol (FTP). Further, the data exchanged over such a network may be represented using technologies, languages, and/or formats that are listed in the definition for the term “web browser.” Encryption protocols are also employed over the internet when data is located and exchanged over the network between connected computers. Suitable encryption technologies may include without limitation: RC2, RC4, R5, RC6, Blowfish, the secure sockets layer (SSL), Secure HTTP and/or virtual private networks (VPNs), the international data encryption standard (DES or IDEA), triple DES, or other known data encryption protocols known in the arts.

The terms “server” and “manufacturer's server” generally refer to a private computer that links other computers or electronic devices together and is accessible over a network, where applications on this private computer can store, back up, organize or modify digital files within the private computer or another computing system respectively. A server may store web pages defined by specific URLs, databases that are relational having a collection of data on individual tables with common or uncommon information, streaming information, and many other differing types of data. A server can be operated and controlled by a private firm. A server administrator may implement and maintain the system and establish policies and procedures pertaining to management, security, maintenance, and use of the server management system. The server of the present invention may implement and understand the programming languages listed above in the web browser definition.

The term “database” generally refers to an application that holds information, or data, that is collected, structured, organized, stored, and controlled by a database management system (DBMS). Together, the data and the DBMS, along with other applications and protocols associated with them, are referred to as a database, which can be connected to a client's computer via the internet to upload or retrieve data therefrom. Data stored on a database is held in tables as a series of rows and columns, making the processing of data queries efficient. In this form, data is easily accessed, managed, modified, updated, controlled, and further organized. Non-limiting embodiments of suitable databases and query languages may include, without limitation: relational databases, non-relational databases, object-oriented databases, entity-relationship model databases, associative databases, XML databases, and databases such as Oracle, MySQL, SQL, PostgreSQL, Sybase, and DB2.

The terms “URL” or “URLs” generally refer to Uniform Resource Locator(s) and is an address for a website located within a server that's connected to the internet. More specifically, the URL points to a specific resource by a protocol identifier (http//) and a resource name (uspto.gov) that is stored on said database. The resource can be a website, database queries, or command outputs or any other data or information that can be stored or retrieved from that particular location. The present invention uses the internet, a sequence of URLs, and other information and resources to allow a client to create instructions for a ready to drink beverage to submit to a beverage manufacturer to then manufacture and ship to the client.

The terms “API” and “APIs” generally refer to an application programming interface that allows two software platforms to communicate and piggyback off each other to share information or functionality between the two giving easier web experiences for users. APIs are heavily used within e-commerce platforms sending HTTP requests that also provide a return path for response messages. APIs can take the form of XML, JSON, SOAP, GraphQL, REST, gRPC, RPC, or any other programming language or protocol that is easy for other applications or webpages to manipulate. APIs work as a middle layer between the client and a server and are responsible for both assembling requests and sending them to API endpoints. APIs can be private, public, or partnered. In addition, there are Web APIs, database APIs, Operating System APIs, and Remote APIs. They allow developers to add functionality, such as payment processing or image recognition, from other third-party providers to existing webpages or to build new platforms using services by third-party providers. In any event, APIs connect two software platforms to another one while hiding the complexity of how the information is shared from a user.

The term “e-commerce” generally refers to an internet platform supplied by a vendor that may be a free-standing online store, a social network, or a social media platform, where customers can initiate purchases via payment requests. An e-commerce platform may be equipped with payment gateways, where financial transactions are delegated to one or more third-party services.

The term “GUI” generally refers to a graphical user interface. GUIs are underlying modules and code that manifest within a web browser as graphical components or interfaces. The actions of a GUI are provided within software, a software application, or a web browser. GUIs require direct manipulation of graphical elements by the user, including but not limited to: graphical buttons, icons, actionable tool bars and ribbons, viewers, a mouse cursor, interactive component menus being lists of clickable items, images that represent information, scrollbars, and the like. GUIs are known within the art for internet users to interact with a provider's website over a network. GUI visual elements represent actions users can take, objects that users can manipulate, and other information relevant to the user's needs. GUIs help hide the complexity of all underlying computer code used to make the website and various webpages of the present invention. The client requires no knowledge of any of the coding languages or protocols listed in the “web browser,” “database,” “module,” or “internet” definitions above to use the same.

### The Beverage Builder

The present invention gives a client the power to initiate the design, manufacture, packaging, and delivery of a shelf stable beverage for consumption or resale. Novice clients with little to no knowledge of the beverage industry can use the computer implemented method to streamline the commercial manufacturing of beverages by remotely designing a ready to drink beverage, thereby removing the need for detailed conversations with a manufacturer when creating the same. Client selection of dynamic beverage attributes create a set of custom instructions for a beverage manufacturer to make a soft drink. These selections, and payment of the same, initiate the manufacturing process of a desired beverage recipe with needed additives and is finished off with proper packaging and shipping by the manufacturer.

More specifically, the method and system provide a pre-made tool with pre-arranged definitions for ready to drink beverage formulations. The web-based method presents and assigns an order of operation as cascading webpages for Core and Customizable Beverage Attributes that a client needs to make decisions when formulating a beverage recipe to submit to a manufacturer. By presenting visual aids and tools as user friendly GUIs for each control point within a client's web browser, client selection of dynamic beverage attributes generates a custom recipe for a beverage manufacturer that triggers the real-world manufacturing of commercial ready to drink beverages with proper packaging and shipping to the client for consumption or resale. Again, these words are not a limitation on the scope of the present invention but are written to detail certain embodiments thereof.

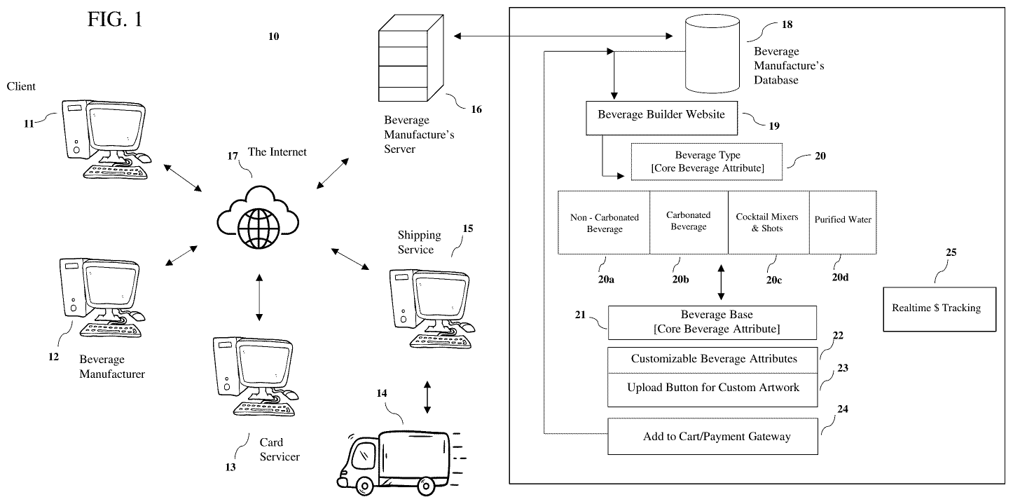

FIG. 1 depicts the present invention 10 as a computer implemented method. A client's computer 11 navigates the internet 17 via a sequence of URLs to resources stored on a manufacturer's server 16. These resources are within a database 18 that presents webpages as a cascading sequence of URLs having selectable options for both Core 20 and Customizable Beverage Attributes 22. The URLs inform the client's computer 11 of the location for the website 19 and its webpages 20, 21, 22 having selectable beverage attributes. Client 11 selections initiate the design, manufacture, packaging, and shipping of a custom-made beverage.

Beverage attributes may contain options, including but not limited to: 1.) Beverage Type [core attribute] 20, 2.) Beverage Base [core attribute] 21, 3.) selection of bottle or can type and size [customizable attribute] 22, 4.) selection of caps or lids [customizable attribute] 22, 5.) selection of primary or secondary flavors [customizable attribute] 22, 6.) selection from a choice of sweeteners [customizable attribute] 22, 7.) selection of color and appearance [customizable attribute] 22, 8.) selection of nutrients [customizable attribute] 22, and 9.) the uploading or selection of custom artwork, labeling, and packaging options [customizable attribute] 23.

The client 11 can opt to submit custom artwork 23 and or other written information for package labeling. The present invention also includes a module 25 that can optionally give second by second pricing driven by client selections, to which the orders are captured and fulfilled via a payment module 24 to fulfill the order for eventual manufacture and delivery to the client for consumption or resale by a shipping service 14, 15. All beverages are exclusively made to order based directly from the client's 11 selections on the beverage builder 10.

Keeping with FIG. 1, an internet service provider (ISP) has computer servers (not shown) that facilitate the web connection 17 between manufacturer's server 16 and the client's device 11 via send/receive modules or platforms known in the art. The client's device 11 uses these ISP connection points to accesses the internet 17, to navigate to and retrieve resources from the manufacturer's server 16, and to retrieve the website 19 via URLs and internet connection protocols, non-limiting examples being automated HTML/PHP/HTTP requests. The ISP server may understand programming languages including but not limited to: Application Programming Interfaces (APIs), Ruby, Liquid, Groovy, HTML, XHMTL, HTML5, DOM, CSS, Java, C++, Pascal, Python, Smalltalk, JavaScript, XML, ColdFusion®, XML/HTTP requests, HTTP/HTTPS/PHP scripts, COBOL, Objective C, Tcl, WebDNA, Active Server Pages (ASP), Perl or the like.

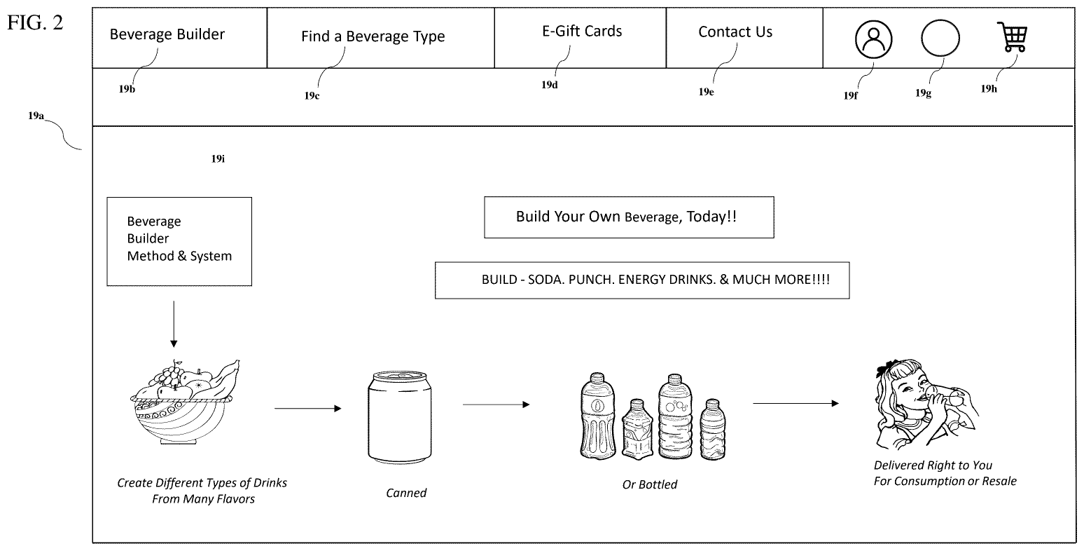

FIG. 2 depicts a nonlimiting example of a landing page 19a for the manufacturer's website. Once the landing page 19a is retrieved, the client's computer is presented with a GUI within their web browser having a series of buttons 19b-19h at the header. These buttons 19b-19h can navigate to other webpages within the website. The client may log into client portal 19f to further personalize the ordering process or continue as a guest. For example, a client may be asked to provide credentials to log into a preexisting account, where client credentials may include without limitation: the client's name, delivery address, zip code, credit card number, email address, and the like. Once logged in, the client is returned to the landing page 19a to start the method of the present invention.

The header for manufacturer's landing page 19a may include buttons for a beverage builder 19b, find a beverage type 19c, e-gift cards 19d, a contact us button 19e, a login portal button 19f, a search tool 19g, and a shopping cart icon 19h. Each button 19b-19h encodes a URL that takes the user to another web experience or webpage. Although the following depicts a client accessing the beverage builder 19b tool from a non-limiting landing page 19a, we feel it is best to present most remaining webpages as a cascading flow of URLs represented by connected rectangles versus showing each and every individual webpage out of context when referencing the same, i.e. most remaining webpages of the present invention are shown as connected rectangles within the manufacturer's server 16 and database 18 (see FIG. 1).

### Selection of Core Beverage Attributes

Manufacturers in the beverage industry categorize their product types as carbonated soft drinks, non-carbonated soft drinks (such as fruit beverages or bottled water), functional beverages (energy and sport drinks), ready-to-drink teas, alcoholic beverages, coffees, and more. Having the client initially select from two core attributes, which we term Beverage Type and Beverage Base, mimic industry practices of how ready to drink beverages are initially understood, formulated, and blended to a final product per the combined efforts of beverage concentrate manufacturers and contracted soft drink makers.

FIG. 1 gives a global view of the present invention 10 that gives a novice client 11 the power to remotely build a commercial ready beverage by navigating a sequence of webpages 20-24. FIG. 2 is the manufacture's landing page for the beverage building website 19. Once the client 11 has selected beverage builder 19b (FIG. 2), a URL navigates the client 11 to a webpage for selecting the first of two core beverage attributes, Beverage Type.

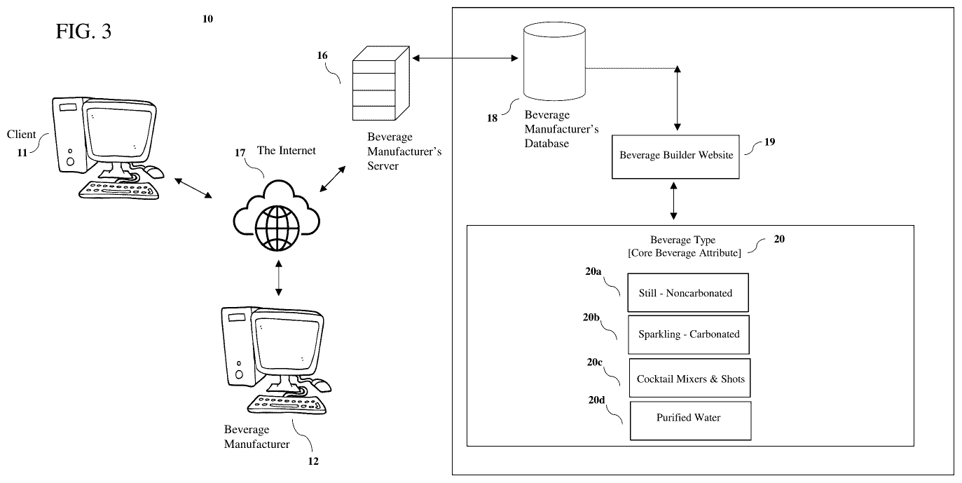

FIG. 3 represents a flow diagram for the first webpage 20 in the beverage building sequence entitled Beverage Type 20. This drawing depicts a schematic for the option flow of choices after the client 11 has selected beverage builder 19b on FIG. 2. Selecting a Beverage Type 20a-20d (FIG. 3) is the first remote instruction from the client 11 to the manufacturer 12. The client 11 can select from Beverage Type 20, including but not limited to: still (non-carbonated) 20a, sparkling (carbonated) 20b, cocktails mixers & shots 20c, or purified water 20d. These options are presented on the webpage 20 as buttons 20a-20d for the client 11 to select.

The Beverage Type 20 represents a key identifier for soft drink manufacturers selling beverage products and is in keeping with people's superficial expectations of commercial beverages. Superficial in that, beverages are either carbonated, or not, or can be purified water, or a beverage used to blend with an alcoholic drink or is an alcoholic drink in and of itself.

People desire carbonated drinks because they are fizzy due to the addition of carbon dioxide to a cold liquid that creates bubbles giving a bit of a kick when consumed. Non-carbonated drinks lack that fizziness and can be more mellow to the taste or serve a medicinal purpose. Each Beverage Type 20a-20d is depicted as a GUI button that hides a URL that when selected, navigates the client 11 to the next set of options within the present invention 10 to select the second Core Beverage Attribute, the Beverage Base.

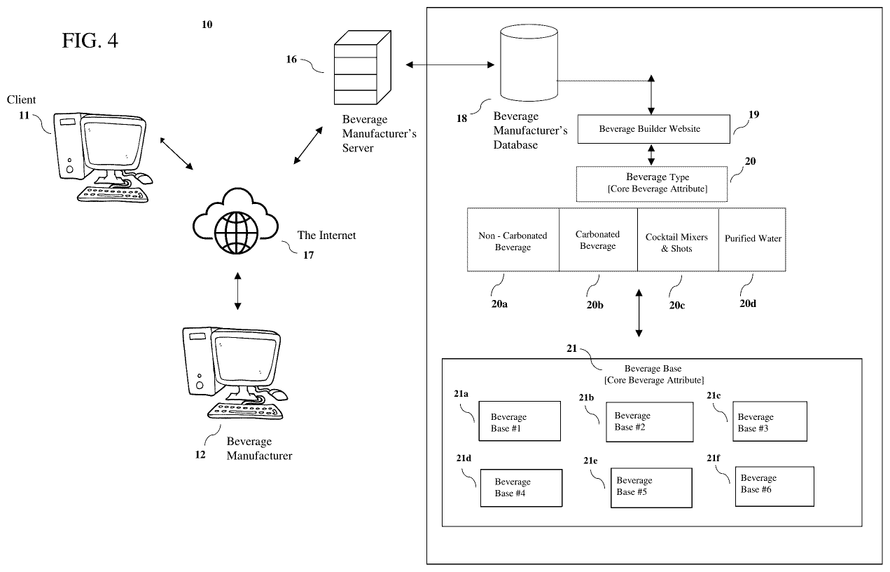

FIG. 4 represents a flow diagram for how the client selects the second core beverage attribute, Beverage Base 21. This drawing depicts a schematic for the option flow of choices after the client 11 has selected the first core attribute, Beverage Type 20 (FIG. 3). The Beverage Base webpage 21 shows how each selection for a base 21a-21f can be depicted as a GUI button that hides a URL that, when selected, navigates the client 11 to the next set of options within the present invention.

The Beverage Base 21a-21f contains options for both non-carbonated 20a, carbonated 20b beverages, and cocktail mixers/shots 20c that may include without limitation: a lemonade concentrate (still), a fruit punch concentrate (still), a craft soda concentrate (carbonated), an energy drink concentrate (carbonated), a sparkling sport water concentrate (carbonated), a sparkling lemonade (carbonated), a sweet tea concentrate (still), a sports drink concentrate (still), a cocktail mixer concentrate (still), or in the alternative, flavor enhanced water or a sparkling or still enhanced or non-enhanced water, or any combinations thereof. For simplicity, we list available beverage bases as Beverage Base #1—Beverage Base #6 21a-21f to show that a manufacturer 12 may have more than one Beverage Base 21 available for a client 11 to select when building their custom beverage.

Beverage bases are the foundations for making soft drinks. Bases are concentrated forms of a finished beverage having all or some of the ingredients needed to make the desired drink and only the necessary amount of water is included to make the viscous formulation. It is well known within the industry that concentrate recipes are often trade secreted, proprietary, and guarded closely with only a few knowing the actual ingredients.

For the present invention, each proprietary Beverage Base 21 formulation is given a title/product name to differentiate them from each other. This naming convention also provides a relatable descriptor to the client when placing an order, wherein naming conventions generalize a beverage type based on preconceived expectations that a consumer would likely have already adopted from everyday retail beverages found at their local retailers.

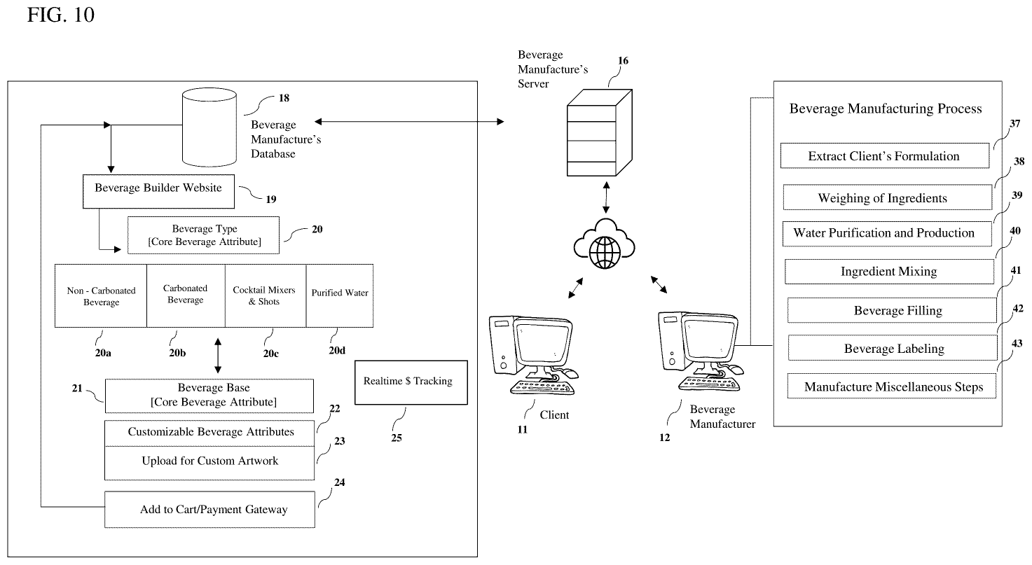

Further selections of Customizable Beverage Attributes will trigger modifications to any proprietary concentrate based on the client's demands. Each proprietary Beverage Base 21 is designed entirely and uniquely to serve as starting formulations for the present invention and are formulated internally at the manufacturer's 12 facilities (see FIG. 10). The manufacturer 12 blends flavors, chemicals, sweeteners, and other raw materials to make proprietary bases, where each concentrate has it's own unique flavor intensity, sweetness level, and nutrient add-ins.

The present invention is not beholden to the use of any one type of beverage base or concentrate, or in the alternative, a collection of beverage bases or concentrate recipes. It is often the case that a formulated beverage base informs a soft drink manufacturer of the needed downstream processes and machines for making the final drink. So long as the manufacturer's website 19 makes the client 11 aware of the available Beverage Bases 21a-21f for making their desired drink, any use of this method with any commercial, artisanal, or amateur beverage base falls within the scope of the present invention 10.

As such, it is an embodiment of the present invention wherein the available menu of Beverage Bases 21a-21f is an assortment of individually premixed concentrates offered to the client 11 as selectable GUI buttons but is partially dictated by the manufacturer's ability to blend, manufacturer, and package those specific types of soft drinks. Each Beverage Base 21a-21f is associated with an internal proprietary recipe that defines said concentrate. Once the client has selected their preferred Beverage Base 21a-21f, the selected GUI button navigates the client 11 to the next set of options within the present invention.

### Selection of Customizable Beverage Attributes

After selecting Beverage Type and Beverage Base, the client navigates to the webpage having Customizable Beverage Attributes. As discussed above, the present invention allows the client to alter proprietary concentrates. Customizable Beverage Attributes are presented to the client as necessary options to create a unique customized beverage that further refines, but not break out from, the proprietary concentrate for subsequent mixing, blending, and bottling or canning by the manufacturer.

However, certain Customizable Beverage Attributes are only selectable, or visible, when compatible with other user selected attributes for that concentrate or finished beverage type. This ensures that the designed formulation complies with FDA guidelines and physical beverage safety parameters. For example, two ingredients that are not compatible with each other cannot both be selected simultaneously to be included in the same beverage to ensure a compatible beverage formulation for manufacturing. The present invention uses this to greater or lesser degrees to control client inputs across all levels for the final beverage parameters, i.e. certain beverage bases and final beverage recipes will not have all ingredients available to the client to add for a final formulation.

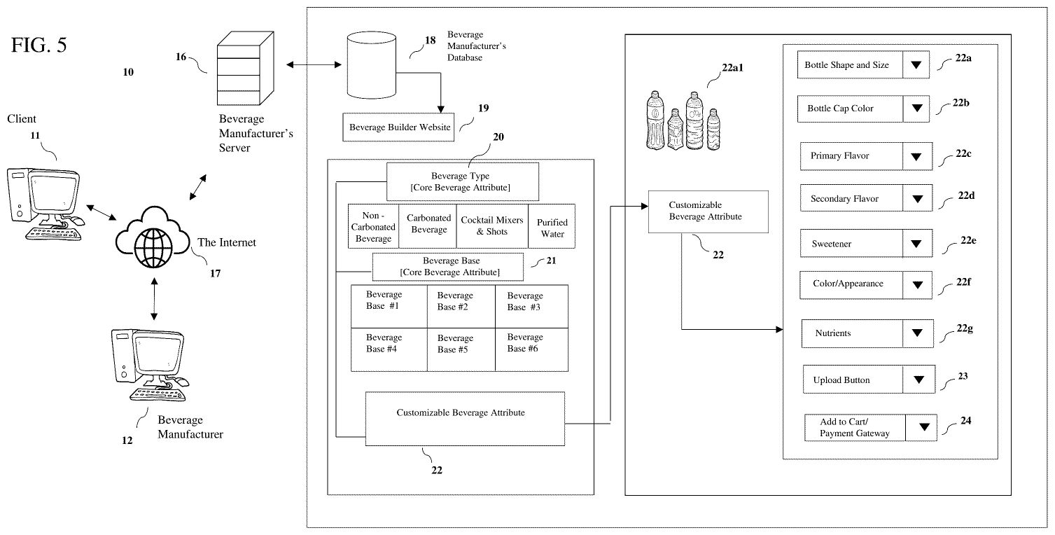

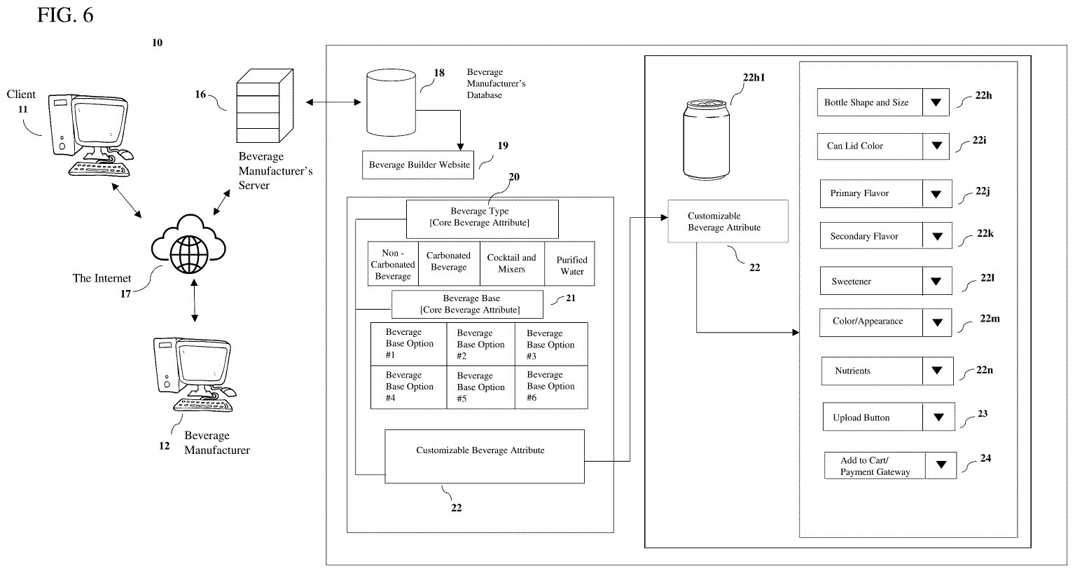

From FIG. 5 or FIG. 6, the client 11 is presented with a series of nested menus for several Customizable Beverage Attributes 22a-22g/22h-22n. Some of the attributes are related to packaging while others are related to concentrate additives/ingredients. FIG. 5 shows a schematic of the option flow of choices for Customizable Beverage Attributes 22a-22g for clients 11 needing bottled 22a1 beverages. FIG. 6 shows a schematic of the option flow of choices for Customizable Beverage Attributes 22h-22n for clients 11 needing canned 22h1 beverages. The detailed description for this section applies to either FIG. 5 or FIG. 6 as the only difference between them is the selection of either a bottled 22al or canned 22h1 beverage.

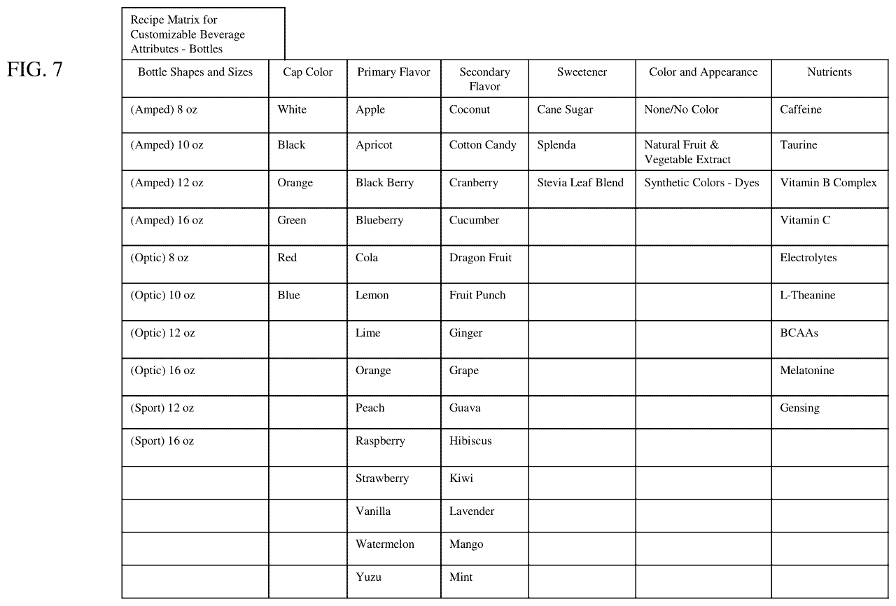

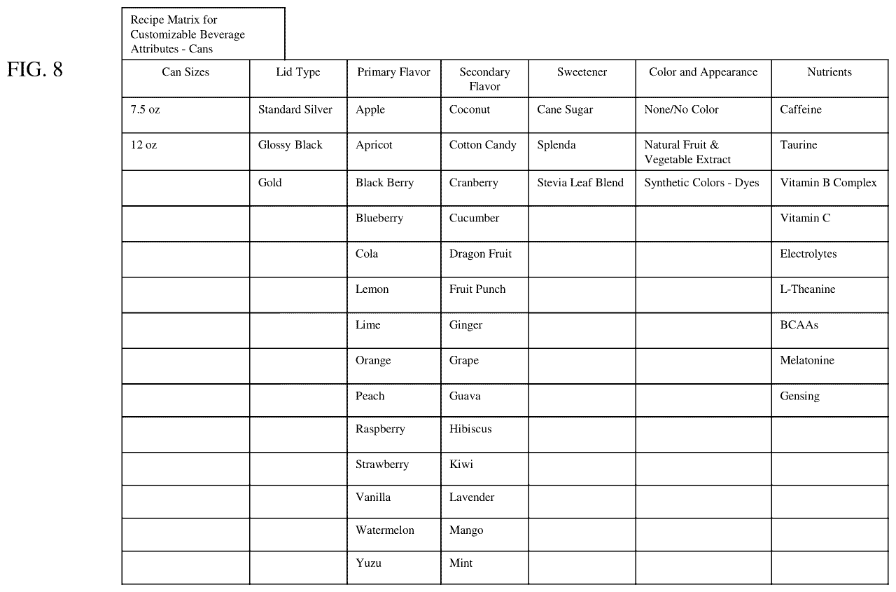

Each Customizable Beverage Attribute 22a-22g/22h-22n has its own collapsible list that, when depressed, gives a dropdown of selectable menu items for that particular option. In a non-limiting example, each nested menu item can be held in a table at the manufacturer's database 18 as a simple 1×1 matrix or something much more complex (See FIG. 7 and FIG. 8), or, in the alternative, each menu item can be stored within the text of the code and retrieved when selected by the client 11. There is no particular order as to how each Customizable Beverage Attribute 22a-22g/22h-22n is presented to the client.

FIG. 7 depicts a table stored within the manufacturer's database. This table holds all selectable options available within the nested dropdowns for each Customizable Beverage Attribute 22a-22g relating to bottled beverages. FIG. 8 depicts a table stored within the manufacturer's database and holds all selectable options available within the nested dropdowns for Customizable Beverage Attribute 22h-22n relating to canned beverages. Either table is shown as a series of connected 1×1 matrices with headers labeling the information for each column. All Customizable Beverage Attributes listed above have their own column within the table for extraction and display within a nested dropdown. When a client selects a particular Customizable Beverage Attribute, information from this table is retrieved by at least one module and inserted into the input filed for such list.

Nested dropdowns are common in web design. They organize and display information more efficiently. A dropdown organizes Customizable Beverage Attributes hierarchically to make selection of these attributes easier for the client to navigate. Dropdowns can be easily created via a combination of HTML for structure, CSS for style, and JavaScript for functionality. The complexity involved is hidden from the user who, in fact, requires no knowledge of such coding languages.

Each nested drop down contains a list of menu items for each Customizable Beverage Attribute. Nested menu items 22a-22g/22h-22n may contain without limitation a bottle size and type, a bottle cap color, a can size, a can lid type, a primary flavoring, a secondary flavoring, sweeteners, optional additives for coloring, and optional nutrients. Bottle shapes may include without limitation: amped, optic, or sport. Bottle sizes may include, without limitation, containers that may hold 8 oz to 16 oz of a beverage. Bottle cap colors may include without limitation: white, black, orange, green, red, and blue. Can sizes may include, without limitation, containers that may hold 7.5 oz to 12 oz of a beverage. Can lids may include, without limitation, standard silver, glossy black, or gold. Primary and secondary flavors may include without limitation: apple, apricot, black cherry, blackberry, blueberry, coconut, cola, cotton candy, cranberry, cucumber, dragon fruit, fruit punch, ginger, grape, grapefruit, guava, hibiscus, kiwi, lavender, lemon, lime, mango, mint, mixed berry, nectarine, orange, papaya, passion fruit, peach, pineapple, prickly pear, raspberry, strawberry, vanilla, watermelon, and/or yuzu. Sweeteners may include without limitation: cane sugar, Splenda, and/or stevia leaf blend. Nutrients might include without limitation: caffeine, vitamin B complex, Vitamin C, L-Theanine, and/or ginseng. Optional additives for coloring may include without limitation: natural fruit and vegetable extracts and/or synthetic colors.

FIG. 5 depicts Customizable Beverage Attributes 22a-22g having the nested options mentioned above, e.g. the type and size of the bottle 22a, the color of the cap 22b used when a bottle 2a is selected, a primary flavor 22c, a secondary flavor 22d, a sweetener 22e, additive for coloring options 22f and nutrients 22g.

FIG. 6 depicts Customizable Beverage Attributes 22h-22n having the nested options mentioned above, e.g. the size of the can 22h, the type of lid 22i used when a can 22h is selected, a primary flavor 22j, a secondary flavor 22k, a sweetener 221, additives for coloring options 22m, and nutrients 22n. An example code for a nested dropdown for the selection of a can size is as follows:
DYMANMIC INGREDIENT SELECTION-DROPDOWN VERSION
<HTML Type CODE>
<select id=“selector dropdown”>
   <option value=“none”>Select an option</option>
   <option value=“7.5 oz Can”>7.5 oz Can</option>
   <option value=“12 oz Can”>12 oz Can</option>
</select>
<JAVASCRIPT>
document.getElementById(‘selector’).addEventListener(‘change’, function( ) {
   var selectedOption=this.value;
   if (selectedOption===‘7.5 oz Can’) {
      document.getElementById(‘selector’).disabled=false;
      document.getElementById(‘12 oz CanOption’).disabled=true;
   } else if (selectedOption===‘12 oz Can’) {
      document.getElementById(‘selector’).disabled=false;
      document.getElementById(′7.5 oz Can′).disabled=true;
   } else {
      //If “Select an option” is selected or no option is selected
      document.getElementById(‘selector’).disabled=false;
      document.getElementById(‘12 oz CanOption’).disabled=false;
      document.getElementById(‘7.5 oz CanOption’).disabled=false;
         Note that this example code can easily be altered by a developer to create the additional nested dropdowns seen in either FIG. 5 or FIG. 6 to accommodate all other menu items listed for each Customizable Beverage Attribute listed above.

As an alternative to nested dropdowns, the website can also present hierarchical selections for anyone of the Customizable Beverage Attributes as selectable radials. Below is an example of HTML/Javascript text for creating such selectable radials for the Customizable Beverage Attribute for nutrients:
DYMANMIC INGREDIENT SELECTION
<HTML Type CODE>
<input type=“checkbox” id=“caffeineIngredientselector” name=“caffeine” value=“120 mg”>
<label for=“caffeineIngredientselector”>Caffeine (120 mg)</label><br>
<input type=“checkbox” id=“melatoninIngredientselector” name=“melatonin” value=“3 mg″>
<label for=“melatoninIngredientselector”>Melatonin (3 mg)</label>
<JAVASCRIPT>
document.getElementById(‘caffeineIngredientselector’).addEventListener(‘change’, function( ){
document.getElementById(‘melatoninIngredientselector’).disabled=this.checked;
});
document.getElementById(‘melatoninIngredientselector’).addEventListener(‘change’, function( ){
document.getElementById(‘caffeineIngredientselector’).disabled=this.checked;
});

Returning to either FIG. 5 or FIG. 6, the manufacturer's database 18 may be relational to store information that defines the Customizable Beverage Attributes 22a-22g/22h-22n listed within each collapsible list. The database 18 is accessible over the network 17 and is kept by a private firm, non-limiting examples being MySQL, Interbase/Firebird, PSQL, IBM, Microsoft/Sybase, Oracle, and the like, where a firm shall have a database administrator or one or more applications developers. The database 18 is associated with at least one module that receives structured language queries from the client's 11 computer whenever a selection for a Customizable Beverage Attribute is made. The client selection informs the system to extract said data from at least one table within the database, thereby confirming the client's section (see FIG. 7 or FIG. 8).

### Client Upload of Custom Artwork or Text

It is known within the art that e-commerce websites allow clients many options to interact with their platform beyond making purchases. One example being a client uploading files to a vendor's server for them to use for some purpose. Returning to FIG. 1, a client may use an upload button 23 to send custom images to the manufacturer's server 16 via the same internet 17 connection. The manufacturer uses the uploaded information to create custom packaging for the client's 11 selected bottles or cans.

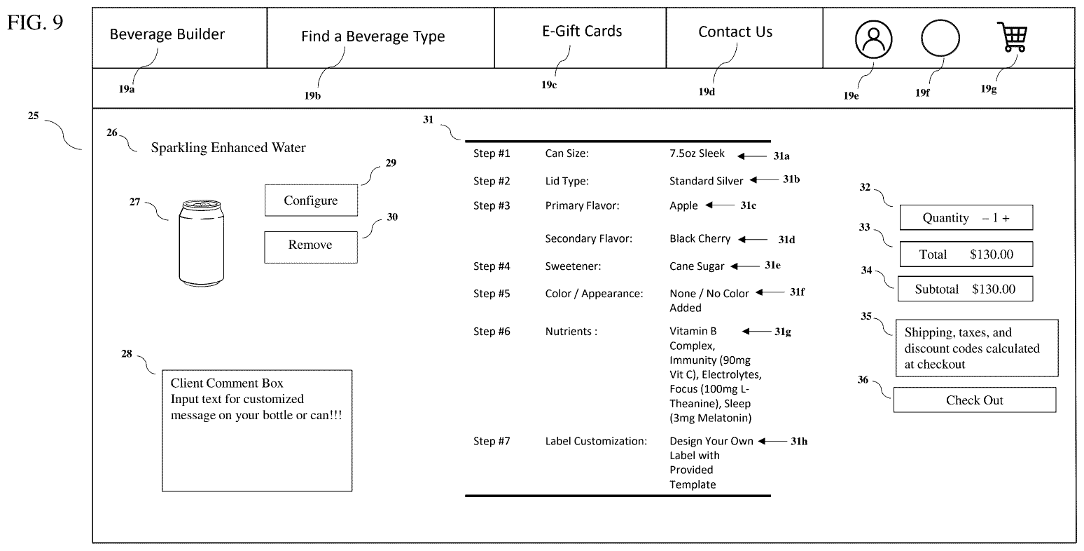

With FIG. 5, once the client 11 has selected all Core and Customizable Beverage Attributes 21, 22, has uploaded an image via the uploader button 23, and has selected the add to cart/payment gateway button 24, the client 11 is navigated to a payment webpage (FIG. 9), where the client is allowed to enter custom text within a comment box for eventual printing on labels for bottles or cans. The manufacturer uses client's chosen text and uploaded image to then customize the front of a blank beverage label (e.g. a business logo or a personalized photo for a family occasion). The manufacturer sends a proof of the graphic design to the client via email for approval before the beverage is manufactured.

Alternatively, the client may opt to create their very own signage for their beverage containers without significant artistic input from the manufacturer. In this embodiment, the manufacturer emails the client a dieline template for them to create and format their own label design. The client uses their own graphic design software, e.g. Photoshop, Paint Shop Pro, or the like, to artistically render the dieline template with their own images, logos, or text. The finished design is then either uploaded to the server by the client or may be emailed directly to the manufacturer. In any case, the manufacturer extracts the clients fully rendered dieline to print the labels for either a can or a bottle.

From either FIG. 5 or FIG. 6, the manufacturer's website 19 presents the client's 11 browser with an upload button 23 that prompts the server 16 to request the location of the client's 11 digital image. Web developers can use PHP, HTML, CSS, API, and JavaScript to tailor GUI buttons with file upload functionality within a basic browser. A real time upload status (not shown) can be made through a set of simple JavaScript events. A developer may use these events to inform upload progress in a webpage. The entire file must be uploaded before the next website events may occur.

To upload digital images to the server 16, at least one graphical user interface, e.g. a GUI button, upload progress handler, or the like, is presented at the client's computer 11 via their web browser over the internet 17. The client 11 clicks the button and at least one module at the server 16 enacts PHP/CSS/HTML/Javascript/API commands that request the file location and digital image for uploading to the server 16.

The client 11 selects the location and image for upload and can be located on the client's computer 11 hard drive, desktop, a flash drive, a mobile device, or any storage location on an electronic device with the ability to store digital photos and connect to the internet 17. It is within the scope of the present invention 10 where the client 11 may upload digital images to the server 16 from a third-party web site or application via XHTML/PHP/Javascript/API protocols known in the art, non-limiting examples being a client uploading a digital image from TikTok, SnapChat, Flickr, Facebook, or the like.

If the image is too large, or too small, or is corrupt, then an error message is returned to the client 11 to select another photo or try to reload the current image. Clients may upload images with non-limiting formats such as: JPG, JPEG, TIFF, PNG, GIF, PDF, RAW, AI, INDD, PSD, and the like. The client has the option to verify that their image file was uploaded correctly and is free of any errors. It is a preferred embodiment of the present invention where the client's digital image ranges in size from about 1 KB to as much as 2 GB. The client's photos must be of a minimum size to reproduce clearly on the dimensions of the dieline template for either a can or a bottle of varying sizes.

Because the manufacturer's website can be custom built by a web developer or be an aggregation of apps from an e-commerce platform, non-limiting examples being Shopify, WIX, Squarespace, BigCommerce, Sellfy, and the like, being able to upload files to the platform is an optional feature for a client using the present invention. Uploading files from the client's computer to the server can be achieved in many ways. Apps that provide the necessary coding to do this may include without limitation: File Uploads by UploadKit, React-Uploady, Uploadery, ClickUpload, Upload Lift, and the like. These software modules can be purchased to seamlessly integrate file-upload features with just a few lines of code. Example code in HTML for an upload button of the present invention is as follows:
FILE UPLOAD FUNCTION BUTTON
<HTML Type CODE>
<input type=“file” id=“fileUpload” accept=“.jpg, .jpeg, .png, .gif, .pdf .ai .psd .png”>document.getElementById(‘fileUpload’).addEventListener(‘change’, function( ) {
   var selectedFiles=this.files;
   var validExtensions=[‘.jpg’, ‘jpeg’, ‘.png’, ‘gif’, ‘pdf’, ‘ai’, ‘psd’, ‘.png’];
   var is Valid=false;
   for (var i=0; i<selectedFiles.length; i++) {
      var fileName=selectedFiles[i].name.toLowerCase( );
      var fileExtension=fileName.substring(fileName.lastIndexOf(‘.’));
      if (validExtensions.includes(fileExtension)) {
         is Valid=true;
         break;
      }
   }
   if (!is Valid) {
      alert (“Please select a valid image or PDF file.”);
      this.value=“;//Clear the input
   }

Dieline templates are cut accordingly from materials like BOPP (biaxially oriented polypropylene) to the size and shape for each can or bottle selected by the client. BOPP is selected for its incredible chemical resistance, adhesive strength, clarity, and temperature resilience. The manufacturer prints client's uploaded images and text upon the BOPP cut dieline template with state-of-the-art 1200×1200 dpi resolution printers paired with ultra chrome pigment inks for maximum color gamut and clarity. The result is true photo realistic image reproduction that really shows off the client's logo and artwork. Optionally, the material may also be laminated with a high clarity polypropylene film to lock in the inks and add a true waterproof barrier.

### Payment & Submission of Client Order for Manufacturing

The beverage is made when the client submits all selections for their Core and Customizable Beverage Attributes, has optionally uploaded their custom artwork for packaging, and has submitted payment for their order. This is shown in FIG. 1. The virtual payment system includes a shopping cart button connected to a payment gateway 24. There is also an optional real time pricing (tracking) module 25.

The purchase experience may include additional webpages for completing the creation of the beverage recipe. These additional webpages may be a part of the virtual payment process and may include without limitation: a shopping cart webpage (see FIG. 9 showing client's chosen recipe 31), a shipping webpage (for entering client information and a location for where the bottled or canned beverages will be sent (not shown)), a payment webpage (for entering payment information, such as credit card, debit card, or checking information, billing and shipping address, a contact phone number, a contact email address, and a final summary of the client's beverage recipe (not shown)), a review webpage (for enabling the client 11 to confirm the beverage recipe as well as the entered shipping and payment information (not shown)), and a confirmation page (for informing the client whether a purchase order has been successfully placed (not shown)).

FIG. 9 is an exemplary shopping cart page 25. The header buttons 19a-19g are the same as for the landing page 19a of FIG. 2. Here, the client is presented with a summary of their selected Core 26 and Customizable 31 Beverage Attributes. In this example the client selected a Beverage Type of Sparkling and a Beverage Base being Sparkling Enhanced Water 26. The client then selected a can 27 size of 7.5 oz 31a, a lid type 31b of standard silver, a primary flavor 31c of apple, and a secondary flavor 31d of black cherry. The next selections for Customizable Beverage Attributes are a sweetener 31e being cane sugar, a selection for color/appearance 31f being none, a selection of nutrients 31g being vitamin B complex, Immunity/Vit C, Electrolytes, Theanine, and sleep/melatonin. The final selection is for client creation of the custom label 31h. These are the instructions the manufacturer will follow when creating the client's custom beverage.

The shopping cart page 25 also allows the client to alter their selection of Customizable Beverage Attributes by depressing the configure button 29, which will navigate back to the selection of Customizable Beverage Attributes of either FIG. 5 or FIG. 6. The client also has the option to remove 30 their product entirely from the shopping cart and start the process all over again. FIG. 9 also gives the client the quantity of products in their shopping cart 32, the total 33 and subtotal 34 pricing thereof, a brief statement on shipping and tax calculations 35, and finally a checkout button 36, which takes the client to a final payment webpage (not shown).

Returning to FIG. 1, client's 11 payment triggers manufacturing of their custom ready to drink beverage. The payment gateway 24 can be a third-party payment API that allows the client 11 to pay for the design, manufacture, and delivery of their custom-made beverage. Such gateways 24 are known within the industry of e-commerce websites and are easily integrated into the present invention via third party API requests, which may include without limitation: PayPal, Venmo, Stripe, Google Pay, Shopify, Amazon Pay, Opayo, Square, Apple Pay, and the like, or any secure banking institution having online payment capabilities via seamless API integration to securely charge a client's 11 credit card via encryption.

Upon payment, the order is submitted to the manufacturer's database 18, where the manufacturer 12 then extracts the client's 11 formulation to begin the manufacturing process. The payment gateway 24 includes a system that documents the client's 11 order as a set of instructions for manufacturing, e.g. beverage type, beverage base, selection of bottle type and size, selection of can size, selection of caps or lids, selection of primary or secondary flavors, selection of sweeteners, selection of color and appearance, and selection of nutrients.

A real time pricing (tracking) module 25 can be a part of the present invention 10. The module 25 can be modified to track changes in the pricing of a client's 11 order due to the additions of various Customizable Beverage Attributes 22 to the shopping cart. Example code for the real time pricing module 25 can also be modified to draw the real time pricing of each individual bottle or can as the recipe is being built by the client 11. Non-limiting example code for the real time pricing 25 calculation of an item or unit, where calculated stock pricing is substituted for calculated unit cost, can be:
Real Time Pricing Module
JAVASCRIPT
jQuery(window).on(‘dpoPrice Update’, function(e,o){
   jQuery(‘.unit-price’).remove( );
   if (!jQuery(‘#options_1018_2’).is (‘:checked’)) {
      jQuery(‘.product_price’).append(‘<b style=“font-size:13px; margin-left: 5px;”
      class=“unit-price”>case
      (only‘+dpoOptions.formatPrice(o.current_prices.price/24)+‘/can)</b>’);
   }
});
jQuery(‘#itoris_dynamicproductoptions select’).each(function( ){if (this.optionList)
jQuery.each(this.optionList, function( ){if (this.origTitle)this.innerText=this.origTitle;});});
jQuery(‘.price-notice’).hide(function( ){this.innerText=this.innerText.replace(‘0.00’,”);});
jQuery(‘.product_quantity label’).append(‘of cases <b style=“font-size:10px;”> (24 cans/case)</b><BR><b style=“color: red; font-size:10px;”> Save up to 40% if buying multiple cases.</b>’)
jQuery(document).ready(function( ) {

Styling customization for the real pricing time pricing module 25 can be in CSS as follows:
.product_price {position: fixed; right: 25px; bottom: 25px; background: #000; color: #fff; padding: 3px 10px; border-radius: 0px; border: 0px solid green; z-index: 10; font-family: Oswald,sans-serif; animation-name: fancypricing; animation-delay: .0 s; animation-duration: 1.3 s; ease-in;}
   product_price {font-size:24px;font-weight:bold;}
   unit_price {font-size:13px!important;}
   @keyframes fancypricing {
   0% {transform:skewX(53 deg)translateX(−500px);opacity:0;}
   60% {transform:translateX(0px);}
   62% {transform:skewX(0 deg)translateX(30px);}
   70% {transform:skewX(−20 deg);opacity: 1;}
   80% {transform:skewX(0 deg)translate(0);}
   90% {transform:skewX(−5 deg);}
   100% {transform:skewX(0 deg);}
   }
   .product_price.fix_price {
   position:absolute;
   left: 0;
   right: 0;
   bottom: −60px;
   transform: none;
   width: 100%! important;
   text-align: center;
   animation-name: fancypricingreturn;
   animation-delay: .0 s;
   animation-duration: .7 s;
   ease-out;
   }
   @keyframes fancypricingreturn
   {0% {transform:skewX(53 deg) translateX(500px);opacity:0;}
   60% {transform:translateX(0px);}
   62% {transform:skewX(0 deg)translateX(30px);}
   70% {transform:skewX(−20 deg);opacity:1;}
   80% {transform:skewX(0 deg)translate(0);}
   90% {transform:skewX(−5 deg);}
   100% {transform:skewX(0 deg);}

Client's 11 payment 24 triggers the commercial manufacturing of the beverage in an FDA registered manufacturing facility, as the beverages are not pre-made. Keeping with FIG. 1, the present invention 10 collects and establishes all the parameters directly from the client 11 via the internet and are eventually housed in the manufacturer's database 18 that is at least capable of rendering SQL modules in an XML script containing the metadata for the client's 11 order. An optional order confirmation email is sent to the client's 11 email address containing the order information, from which, all client 11 selections are then extracted from the database 18 by the manufacturer 12 to convert the client's 11 selection of dynamic beverage attributes into a ready to drink beverage for consumption or resale.

From FIG. 10, the manufacturing process of the present invention may include without limitation: the weighing of ingredients 38, water purification and production 39, the mixing of ingredients 40, beverage filling 41, beverage labeling 42, and other miscellaneous steps 43. All steps are done to prepare what clients would expect in a ready to drink beverage they would find on the shelves of their local supermarkets. As such, only blocked diagrams of the processes are shown.

The manufacturer 12 digitally formulates and fortifies the beverage with all the components 37 selected by the client 11 to create a batch formulation. A prototype of the client's 11 beverage is compounded to ensure that the formulation is safe and meets FDA standards for shelf stability and the manufacturer's 12 own internal Hazard Analysis Critical Control Point (HAACP) plan (not shown).

The weighing of ingredients 38 can be done with a laboratory gram resolution scale, where the amount of the ingredients will be dictated by the size of the container selected as a Customizable Beverage Attribute. Water filtration systems are used to ensure that high quality water dilutes the Beverage Base before being mixed with other ingredients, where filtration systems may include, without limitation, a reverse osmosis membrane filter, a coconut shell carbon sediment filter, or an ultraviolet spectrum disinfectant for further sterilization. Mixing ingredients 40 can be done within a 5 gallon to 500 gallon NFS open top mixing vessel made from polypropylene and stainless steel having a pneumatic air driven high sheer rotating agitator/mixer, where an electric motor drives and rotates such agitator/mixer.

Beverages are filled 41 in either bottles or cans with an isobaric and atmospheric beverage filling line having: an automated or manual empty container infeed, an automatic liquid filling and metering stage, an automatic sealer for the beverage container, and a machine for the rinsing and cleaning of the beverage container's exterior. The bottle or can is then labeled via an automatic roll fed pressure sensitive label applicator and a video inkjet spray date coder. Before the final product is shipped to the client 11, the manufacturer and client may optionally communicate to discuss, and approve, any uploaded 23 digital renders of client's 11 chosen label design before such labels are printed and attached to any bottle or can.

Movement along the beverage manufacturing line includes numerous belt driven conveyances, fork lifts for moving pallets of client's bottled or canned beverages within a warehouse, commercial refrigeration to store formulation ingredients or finally sealed beverages, and, lastly, a quality assurance laboratory that at least includes a pH meter, testing strips, and a Brix Refractometer.

The cost to the client for the creation and shipping of custom beverages from the manufacturer can be presented either at the end of the purchasing process or alternatively via the real time pricing module. FIG. 1 shows the internet 17 connecting the manufacturer's server 16 with third party computers belonging to shipping services 14, non-limiting examples being: United Parcel Service (UPS), United States Postal Service (USPS), Federal Express (FedEx), Dalsey, Hillblom, and Lynn (DHL), or local and regional couriers capable of shipping manufactured beverages to a client 11.

For instance, shipping the client's 11 order to their desired location is possible by integrating the payment gateway 24 with an API provided by known shipping and carrier services 14, 15. The API request can also include details about the transaction such as manufacture's 12 pickup location for the shipment, description of the product, size information, the client's 11 name and delivery address, zip code, email address, along with other contact details, shipping costs, any applied discounts, and etc., where the client's 11 address can be used to determine shipping costs. Using APIs from reputable carriers enable the present invention 10 to provide the manufacturer's website 19 with shipping functionality, for example, the creation of shipping labels or rate information, possible real-time delivery updates, tracking of the client's order, and the like, without directly coding for such.

### A Canned Water Variation and the System

It is an embodiment of the present invention wherein the beverage manufacturer provides a website over a network for the client to select the Core Beverage Attribute (Beverage Type) of purified water to create a custom beverage. This ensures that the client is creating a purified canned water beverage where there is no initial beverage concentrate added to the formulation. From FIG. 4, if the client 11 selects purified water 20d as the Beverage Type 20, then the system navigates to a webpage to create a purified canned water as the beverage formulation.

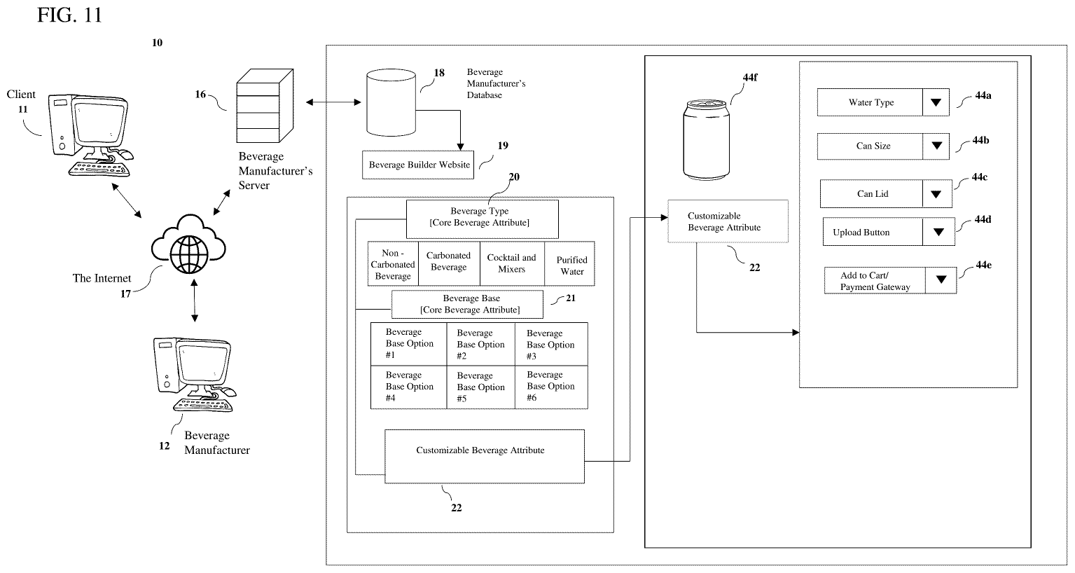

FIG. 11 depicts several Customizable Beverage Attributes 22 for the client 11 to create a purified canned water. The Customizable Beverage Attributes 22 are: a water type 44a, a can size 44b, and a can lid 44c to create a custom beverage. Because the beverage is a canned purified water 44f, the primary flavor, the secondary flavor, the sweeteners, the nutrient additions, and the color additives are removed as Customizable Beverage Attributes 22. The limited Customizable Beverage Attributes 22 are presented as a series of nested menus for which the client can choose (see example code above). Again, FIG. 11 shows a schematic of the option flow of choices for Customizable Beverage Attributes 22 for clients 11 needing a canned purified water. Some of the attributes are related to packaging 44d while others are related to water types 44a and can sizes 44b. Considering what was just described, all other steps for using the method and system to create a canned water beverage are the same as described above.

The client 11 still uses the website to submit payment 44e to the beverage manufacturer 12 for the custom beverage thereby initiating the manufacture, packaging, and shipping of a custom beverage to the client 11. This variation of the present invention allows the client 11 to select a water type 44a, being either a purified still water or a purified sparkling water. The client 11 has the option to select can sizes 44b from 7.5 oz to 16 oz and the can lid 44c type as standard silver. The client 11 may use the website to upload custom artwork and text information 44d for the beverage manufacturer 12 to extract and use to label packaging for a beverage container. In this version of the invention the beverage manufacturer 12 creates differing types of canned water 44f with the option of a custom label provided by the client 11 to the beverage manufacturer 12. Client payment 44e of the order to the beverage manufacturer 12 will initiate the manufacture, packaging, and shipping of the custom beverage to the client 11.

FIG. 1 is not only a method of the present invention but also a system. The way we use the client's computer 11, the internet 17, the beverage manufacturer's remote server 16, database 17, networked connections to payment gateways 24, and networked connections to shipping services 14, 15 detail a system for the present invention. The system aids in the remote streamlining of the beverage manufacturing process, giving a client 11 the power to create a custom made beverage via a client computer 11 networked 17 and connected to a beverage manufacturer's computing server 16, and gives access to a relational database 18 with the beverage building website 19 having a series of selectable Core Beverage Attributes 20, selectable Customizable Beverage Attributes 22, an image upload button 23, and a payment gateway 24.

The beverage manufacturer's 12 computing server 18 has storage memory capable of retaining client 11 selections of Core Beverage Attributes 20 and Customizable Beverage Attributes 22. The system includes the beverage manufacturer 12 having an additional computer capable of communicating with the computing server 18 to extract all of client's 11 Core Beverage Attributes 20 and Customizable Beverage Attributes 22 after client's computer 11 has authorized payment via the payment gateway 24. The beverage manufacturers' 12 second computer is capable of transferring the extracted Core Beverage Attributes 20 and Core Beverage Attributes 22 to a beverage manufacturers' 12 beverage production facility having at least a laboratory gram resolution scale, a water filtration system having at least reverse osmosis membrane filter, a coconut shell carbon sediment filter, or an ultraviolet spectrum disinfectant for further sterilization, a 5 gallon to 500 gallon NFS open top mixing vessel, an isobaric and atmospheric beverage filling line with an automated or manual empty container infeed, an automatic liquid filling and metering stage, an automatic sealer for the beverage container, a machine for the rinsing and cleaning of the beverage container's exterior, and an automatic roll fed pressure sensitive label applicator and a video inkjet spray date coder. The beverage manufacturers' 12 second computer is networked with a different remote computer 15 or server operated by a shipping or delivery service 14. If taken in context with what has been written above, this system is vital to facilitate the present invention. System computer capabilities can be found in the definition section above.

Exemplary aspects of a method and system that streamlines the design, manufacture, and delivery of a ready to drink commercial beverage to an end user are described. It is, of course, not possible to describe every conceivable combination of components for the method and system for purposes of describing these aspects, but one of ordinary skill in the art can recognize that many further combinations are possible. The invention is not limited to the design, manufacture, or delivery of one type of beverage but focuses on the application of a method and system which can be applied to create differing types of beverages to be captured by the current invention. Numerous alternative embodiments could be implemented using either current technology or technology developed after this filing date but would still fall within the scope of our claims defining the invention.

We claim:

1. A method to remotely streamline a beverage manufacturing process comprising the steps of:
a. a beverage manufacturer providing a website over a network;
b. a client using the website to select two Core Beverage Attributes to create a custom beverage formulation;
c. the client further using the website to select from a series of Customizable Beverage Attributes to create the custom beverage formulation; and
d. the client using the website to submit payment to the beverage manufacturer for the custom beverage formulation thereby initiating the manufacture, packaging, and shipping of a custom beverage to the client.

2. The method of claim 1, wherein the client uses the website to upload custom artwork and text information for the beverage manufacturer to extract and use to label packaging for a beverage container.

3. The method of claim 1, wherein the two Core Beverage Attributes include a Beverage Type and a Beverage Base.

4. The method of claim 1, wherein the series of Customizable Beverage Attributes include: a bottle type, a bottle size, a can size, a choice of bottle cap color, a choice of can lid type and color, a primary flavor, a secondary flavor, a selection of nutrients, a selection of sweeteners, a selection of optional color additives, and any combinations thereof.

5. The method of claim 3, wherein the bottle type includes amped, optic, or a sport type bottle.

6. The method of claim 3, wherein the bottle size includes 8 oz to 16 oz bottles.

7. The method of claim 3, wherein the can size includes 7.5 oz to 12 oz cans.

8. The method of claim 3, wherein the primary and secondary flavors include: apple, apricot, black cherry, blackberry, blueberry, coconut, cola, cotton candy, cranberry, cucumber, dragon fruit, fruit punch, ginger, grape, grapefruit, guava, hibiscus, kiwi, lavender, lemon, lime, mango, mint, mixed berry, nectarine, orange, papaya, passion fruit, peach, pineapple, prickly pear, raspberry, strawberry, vanilla, watermelon, yuzu, and any combinations thereof.

9. The method of claim 3, wherein the selection of sweeteners include: cane sugar, Splenda, stevia leaf blend, and any combinations thereof.

10. The method of claim 3, wherein the selection of nutrients include: caffeine, vitamin B complex, Vitamin C, L-Theanine, ginseng, and any combinations thereof.

11. The method of claim 3, wherein optional additives for coloring include: natural fruit coloring, vegetable extract coloring, synthetic coloring, and any combinations thereof.

12. The method of claim 1, wherein the uploaded custom artwork is either in a GIF, a JPEG, a PNG, a TIFF, a BMP, a SVG, an EPS, an AI, or a PDF format.

13. The method of claim 1, wherein the manufacturer sends the client a dieline template to create their own custom artwork for packaging and labeling.

14. The method of claim 1, wherein the manufacturer is a beverage manufacturer capable of initiating the creation of client's custom beverage by extracting a client formulation from a server and initiates manufacturing of the beverage via a production line capable of weighing client ingredients, water purification and production, mixing and blending of a beverage base with client's ingredients, beverage filing, and beverage labeling.

15. A method to remotely streamline a beverage manufacturing process comprising the steps of:
a. a beverage manufacturer providing a website over a network;
b. a client using the website to select a Core Beverage Attribute to create a custom beverage;
c. the client further using the website to select from a series of Customizable Beverage Attributes including a water type, a can size, and a can lid type to create a custom beverage formulation;
d. the client using the website to submit payment to the beverage manufacturer for the custom beverage thereby initiating the manufacture, packaging, and shipping of a custom beverage to the client.

16. The method of claim 15, wherein the water type is either a purified still water, or a purified sparkling water.

17. The method of claim 15, wherein the can size is from 7.5 oz to 16 oz and the can lid type is standard silver.

18. The method of claim 15, wherein the client uses the website to upload custom artwork and text information for the beverage manufacturer to extract and use to label packaging for a beverage container.

19. A system for remotely streamlining a beverage manufacturing process comprising:
a. a client computer networked to a beverage manufacturer's computing server having at least one relational database with a website having a series of selectable Core Beverage Attributes, selectable Customizable Beverage Attributes, and a payment gateway;
b. the beverage manufacturer's computing server having storage memory capable of retaining the client selections of Core Beverage Attributes and Customizable Beverage Attributes;
c. a beverage manufacturer having a second computer to capable of communicating with the computing server to extract all of client's Core Beverage Attributes and Customizable Beverage Attributes after client computer has rendered payment via the payment gateway;
d. the beverage manufacturers' second computer being capable of transferring the extracted Core Beverage Attributes and Core Beverage Attributes to a beverage manufacturers' beverage production facility having at least a laboratory gram resolution scale, a water filtration system having at least reverse osmosis membrane filter, a coconut shell carbon sediment filter, or an ultraviolet spectrum disinfectant for further sterilization, a 5 gallon to 500 gallon NFS open top mixing vessel, an isobaric and atmospheric beverage filling line with an automated or manual empty container infeed, an automatic liquid filling and metering stage, an automatic sealer for the beverage container, a machine for the rinsing and cleaning of the beverage container's exterior, and an automatic roll fed pressure sensitive label applicator and a video inkjet spray date coder; and
c, wherein the beverage manufacturers' second computer is networked with a different remote computer or server operated by a shipping or delivery service.
